(19) United States
(12) Patent Application Publication
(10) Pub. No.: US 2004/0113780 A1
(43) Pub. Date: Jun. 17, 2004

(54) Military tripwire alarm for battlefield defensive perimeter security

(76) Inventor: Michael D. Pottratz, Lakewood, WA (US)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 10/356,198

(22) Filed: Jan. 30, 2003

Related U.S. Application Data
(60) Provisional application No. 60/431,376, filed on Dec. 5, 2002.

(51) Int. Cl. G08B 13/00

(52) U.S. Cl. 340/550; 340/548

(57) ABSTRACT

A weather resistant, battery powered tripwire warning device includes a weather resistant housing, a battery mounted within the housing, an alarm mounted within the housing, at least one spotlight mounted on a side of the housing and configured to illuminate regions extending from the side of the housing, and at least one and preferably a pair of switches mounted on opposing sides of the housing and configured to close a circuit between the alarm and the battery when either switch is activated. Each switch is configured to be attached to a trip cord, such that a selected tension on the trip cord will activate the alarm. The tension required for activation of the switches is individually adjustable. The battery powered tripwire device may be employed for perimeter security of a military force or for training exercises.

### BACKGROUND OF THE INVENTION

1. Field of the Invention

This invention relates generally to military early warning devices and outdoor alarm systems particularly those utilized to protect battlefield defensive perimeters.

2. Description of the Related Art

Throughout the years militaries have employed a variety of methods to ensure defensive security. During World Wars I and II, soldiers would emplace tin cans filled with rocks along concertina wire to provide early warning of enemy soldiers entering a perimeter. For obvious reasons, this tin can security system was neither effective nor easily employable. In later years, pyrotechnic tripwire devices were employed, which are still used today, to provide alert in the presence of intruders. These pyrotechnic devices are hazardous for soldiers to carry and store, and require significant technical knowledge to implement. In addition, some pyrotechnic tripwire devices are lethal by nature, which poses a problem for operations other than war.

The great increase in non-combat military operations has left a gap in the ability of the military to provide a system that affords non-lethal battlefield security. During non-combat operations, civilians and combatants alike pose a variety of threats to the military. However, the use of lethal tripwire devices is extremely problematic. For example, such devices fail to distinguish between friendly and enemy. This problem has increased with United Nations Resolution 54/58 of 1 Dec. 1999, and other resolutions referring to the “Convention on Prohibitions or Restrictions on the Use of Certain Conventional Weapons Which May Be Deemed to Be Excessively Injurious or to Have Indiscriminate Effects”, and in particular, the “amended Protocol on Prohibitions or Restrictions on the Use of Mines, Booby Traps and Other Devices” (Protocol II) implementing a ban on all lethal remote land mine and tripwire devices.

Additionally, the military has a need for devices that may be used to train personnel in placement and detection of such equipment. It is not reasonable to assume that, because the US military has acknowledged and accepted the ban on such devices, hostile forces will accept the same limitations. Thus, it is essential that non-lethal devices be available for such training. Coupled with the inherent hazards and increased costs associated with known non-lethal pyrotechnic devices, the gap in military technology, and the need for a non-hazardous, easily deployable battlefield security device is evident. Such a device must be ergonomic, cost effective, simple to implement, adaptable to harsh environments, and be able to signal a security breech at a variety of distances.

A known device employs a chemical light coupled with a spring-loaded hammer. When an intruder trips the device, the hammer is released to break a glass ampoule, allowing reactive chemicals to mix, which produces the chemical light. The device is safe to carry and simple to install. However, it has significant drawbacks. For example, the light produced is not easily visible in daylight. Even at night, the chemical response is not instantaneous, but may be delayed by several seconds, as the chemicals mix and begin to produce light. Thus, an intruder may be able to move away from the vicinity or disable the device before the intrusion is detected.

More sophisticated electronic sensors, employing technologies common in building security systems, for example, such as laser sensors, infrared, and motion detectors, are not considered practical for a variety of reasons, including the level of training required to operate, the difficulty in preventing false alarms due to unpredictable environmental conditions, and the cost of such high-tech equipment.

### BRIEF SUMMARY OF THE INVENTION

According to an embodiment of the invention, a tripwire device is provided as a training aid for military soldiers and as a non-lethal perimeter defense tool. The device is configured to be mounted in a housing that is adaptable to harsh outdoor environments and permits installation in a wide variety of outdoor locations. Ideally it utilizes both audio and visual means to indicate detection of movement at a variety of distances from an observation point.

According to a further embodiment of the invention, A tripwire warning device is provided, including a weather resistant housing, a battery mounted within the housing, an alarm mounted within the housing, a pair of switches mounted on opposing sides of the housing and configured to close a circuit between the alarm and the battery when activated, and further configured to be attached to trip cords, such that a selected tension on either of the trip cords will activate the alarm. According to an embodiment of the invention, the device includes a pair of spotlights mounted on opposing sides of the housing and configured to illuminate regions extending from the opposing sides of the housing when either of the switches is activated. The switches are individually adjustable for the tension required to activate the alarm function.

According to another embodiment of the invention, a method of operation is provided.

According to an additional embodiment of the invention, a training method is provided that utilizes a battery powered tripwire device formed in accordance with the foregoing embodiments.

### BRIEF DESCRIPTION OF THE DRAWINGS

FIG. 1 shows an isometric view of a battery powered tripwire device in use according to an embodiment of the invention;

FIGS. 2 and 3 show partially exploded views of the device of FIG. 1;

FIGS. 4A-4C show a pull tab modified to adjust activation tension of the device of FIG. 1;

FIG. 5 shows the device of FIG. 1 deployed in a battlefield;

FIG. 6 shows the device being activated by an intruder; and

FIG. 7 shows the device being activated by an intruder in darkness.

### DETAILED DESCRIPTION OF THE INVENTION

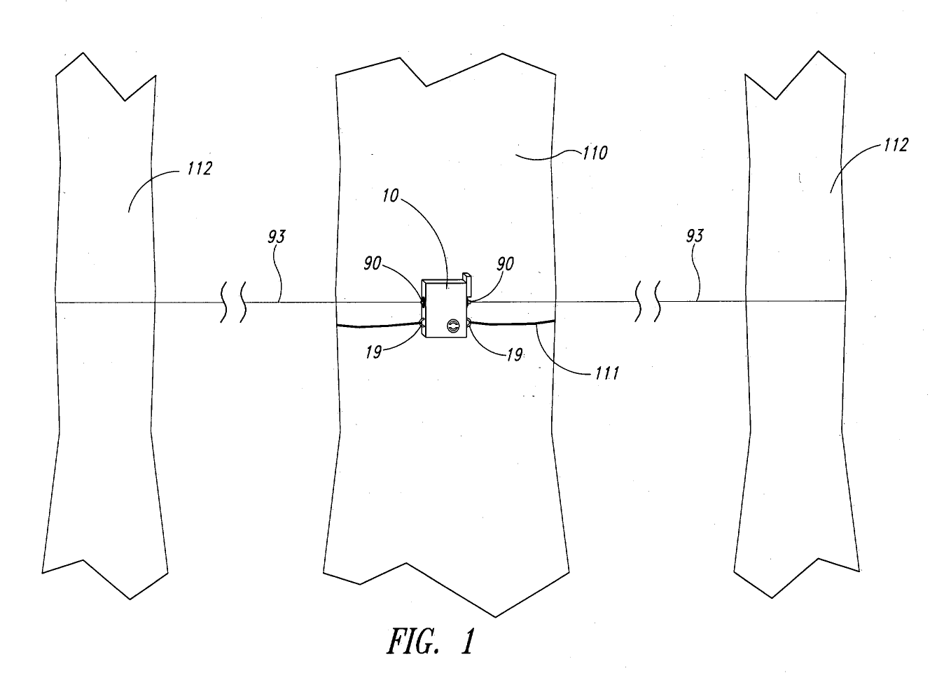

According to an embodiment of the invention, a battery powered tripwire device is provided. One example of such a device is described with reference to FIGS. 1-3.

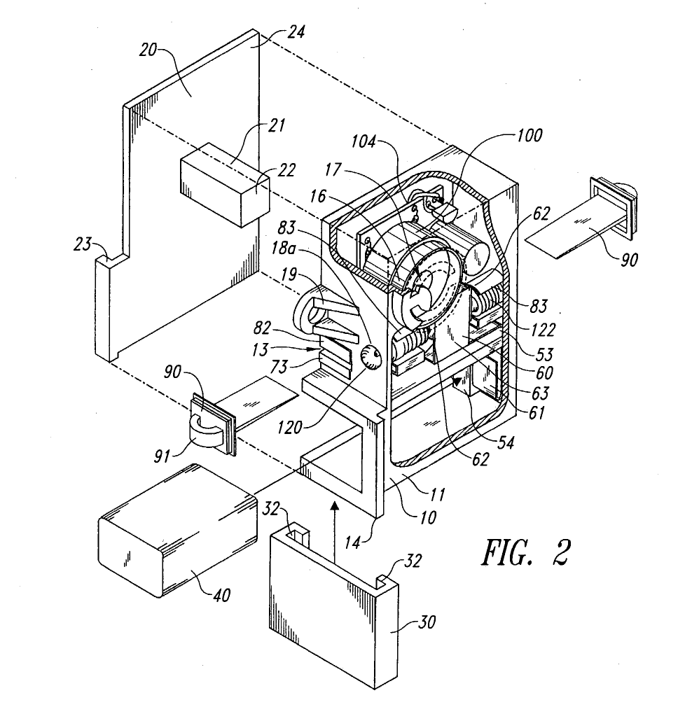

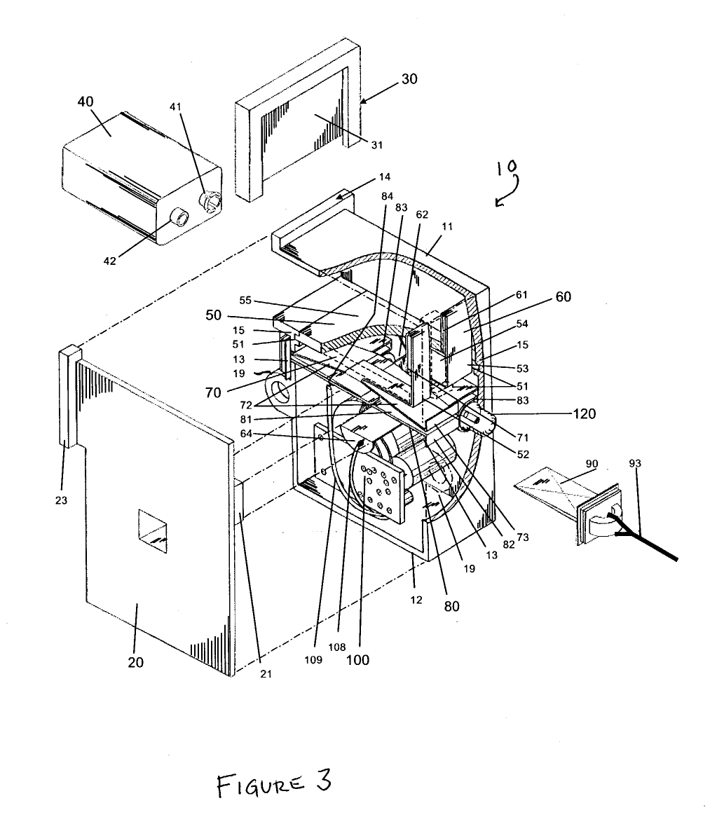

FIG. 1 shows the tripwire alarm for a defensive perimeter security 10, while FIGS. 2 and 3 illustrate partially exploded views of the tripwire alarm 10 from opposite sides of the device. As shown in FIGS. 2 and 3, the tripwire alarm 10 consists generally of a cubical housing 11, a back cover plate 20 of the housing, a battery cover 30, a battery 40, a unidirectional terminal separator and battery holder 50, a negative power terminal 60, a positive power terminal 70, a positive contact plate 80, a two variably sensitivity water resistant pull tabs 90 attached to trip cords 93 of a length suitable to be secured at locations 25-50 meters from the pull tabs 90, and a high decibel siren 100.

As shown in FIGS. 2 and 3, the tripwire alarm 10 includes a generally cubical housing 11. The housing is formed from high-density, impact resistant plastic. The rim 12 of the housing 11 mates with the rim 24 of the back cover plate 20 by means of waterproof cement such as dichloromethane, or by other conventional attachment means. Pull tab notches 13, located on opposite sides of the housing 11, are identical in size and are positioned in axial alignment with respect to each other. Alignment folds 73, 82 of the dual spring switch 72 and the positive contact plate 81 slide into the pull tab notches 13. The notches 13 are large enough to allow the upper leaves 74 of the dual spring switch 72 to move freely, in such a way that the variably sensitive pull tabs 90 may be inserted between the respective upper leaf 74 and the positive contact plate 81. The battery cover slip 14 is configured to cooperate with the slip 23 located on the back cover plate 20. When the rim 12 of the housing 11 mates to the rim 24 of the back cover plate 20, a generally rectangular slip is formed. This rectangular slip mates with the slot 32 of the battery cover 30 to form a weather resistant seal around the perimeter of the rectangular slip.

Integrated into the generally cubical housing 11 are battery holder slots 15a and 15b that are configured to receive the battery holder 50. The battery holder 50 slides into the battery holder slots 15a and 15b and is trapped therein when the back cover plate 20 is affixed to the housing 11. The unidirectional terminal separator 54 may be formed as an integral part of the battery holder 50 or as an integral part of the cubical housing 11.

The cubical housing 11 includes the siren outlet 17, and is configured to securely receive the siren 100 within the housing 11 and aligned with the outlet 17. The siren outlet 17 permits the sound of the siren 100 to propagate from the housing 11 toward a defensive position.

Integrated into the housing 11 are spot light outlets 18 that are configured to permit pre-focused spot lights 120 to slide from the interior cavity of the box 11 through the respective outlets 18 and expose the tips of the lenses of the spotlights 120 to the outside of the box 11. The diameter of the spot light outlets 18 conforms to the shape of the spot lights 120, and secures them inside the housing 11. The spot light rims 122 may be coated with conventional sealant to prevent condensation inside the housing 11. The pre-focused spot lights 120 may be conventional visible light spots or infrared spots, which produce a light that is invisible to the naked eye.

Securing brackets 19 are located on either side of the housing 11. The securing brackets 19 are formed integrally with the housing 11. The securing brackets 19 permit the tripwire device 10 to be attached to an object, such as a tree 110 or post, etc., by means of a high strength chord, steel wire 111, or nails.

The back cover 20 consists of a generally planar surface with prominent rectangular out cropping. The back cover 20 is formed from high-density, impact resistant plastic. When the back cover 20 is mated to the housing 11, the spot light securing post 21 pushes the negative spotlight power leaflets 62 against the negative contacts of the spotlights 120, which in turn locks the spot lights 120 into the spot light outlets 18. The tip 22 of the spot light securing post 21 further locks the negative power contact 60 into the housing 11 by pressing against a portion 63 of the contact 60 in the space separating the two negative spotlight power leaflets 62.

The battery cover 30 is generally rectangular in shape. The battery cover 30 may be formed from high-density rubber or plastic. The slots 32 of the battery cover 30 are configured to slide onto the slips 23 and 14 of the housing 11 and cover plate 20, closing the battery port 13 in a water tight or water resistant closure. The housing 20 and battery cover 30 are sized and configured to push the positive battery terminal 42 of a conventional 9-volt battery 40 against the positive spring terminal 71 and the negative battery terminal 41 against the negative spring contact 61 when the cover 30 is in place on the housing 11.

The unidirectional terminal separator 54 is positioned in the housing 11 and defines two notches 52, 53. A small notch 52 restrains the positive contact terminal 71 to the housing 11 when the battery holder 50 is locked into the cubical housing 11. A large notch 53 restrains the negative contact terminal 61 to the housing 11 when the battery holder 50 is locked into the cubical housing 11. The unidirectional terminal separator 54 is configured to correctly align the positive and negative terminals 42 and 41 of the battery 40 with the positive battery contact terminal 71 and the negative battery contact terminal 61, respectively. If the battery is inadvertently reversed in the housing 11, the terminals 42 and 41 of the battery 40 will be restrained from making reversed polarity contact, since the larger, negative battery terminal 41 is too large to fit into the small notch 52. In such a situation, the battery 40 cannot be fully inserted into the battery port 13, which, in turn, prevents the cover 30 from being closed. Thus, an operator is immediately made aware of the incorrect alignment of the battery.

The negative power terminal 60 incorporates the negative battery contact terminal 61, the negative spotlight power leaflets 62, and negative siren contact 64, and it is formed from a non-corroding and non-oxidizing conductive metal such as brass or aluminum. The negative battery contact terminal 61, by the nature of its shape has a springing action. The negative battery terminal 41 is pressed into the negative battery contact 61 by the force of the battery 40 against the battery cover 30. The negative spotlight power leaflets 62 are half circular in shape and configured to contact the negative terminals of the spotlights 120. The distance between the negative spotlight power leaflets 62 is such that the tip 22 of the securing light post 21 forces the leaflets 62 against the negative terminals of the spotlights 120, and locks the spotlights 120 to the housing 11.

The positive power terminal 70 incorporates the positive battery contact 71 and the upper leaves 74 of the dual spring switch 72, and it is formed from non-corroding and non-oxidizing conductive metal such as brass or aluminum. The positive battery contact 71, by the nature of its shape, has a springing action. The positive battery terminal 42 is pressed into the positive battery contact 71 by the force of the battery 40 against the waterproof battery cover 30. The prominent feature of the positive power terminal 70 is the dual spring switch 72. The upper leaves 74 of the dual spring switch 72 move freely, in such a way that the variably sensitive water resistant pull tabs 90 can be inserted, and when removed, the upper leaves 74 naturally expand to contact the positive contact plate 81. The spring alignment folds 73 of the upper leaves 74 engage respective contact plate notches 13, keeping the positive power terminal 70 locked in the housing 11, while permitting motion of the upper leaves 74.

The positive contact node 80 incorporates a positive contact plate 81, positive light contacts and holders 83, and a positive power supply point 84, formed from non-corroding and non-oxidizing conductive metal such as brass or aluminum. The generally planar, positive contact plate 81 is contacted by the spring action of the upper leaves 74 of the dual spring switch 72 when either of two variably-sensitive water resistant pull tabs 90 are removed. The plate alignment folds 82, located on the sides of the contact plate 81, engage respective contact plate notches 13, locking the positive contact node 80 to the housing 11. The spotlights 110 are further locked into the housing by the positive light contacts and holders 83, which have a semi-cylindrical shape to hold the spotlights 120. The light contacts and holders 83 supply positive power from the battery 40 when the circuit is completed by the removal of either variably sensitive water resistant pull tabs 90. Positive power is supplied to the siren 100 via a connection soldered to the positive power supply point 84.

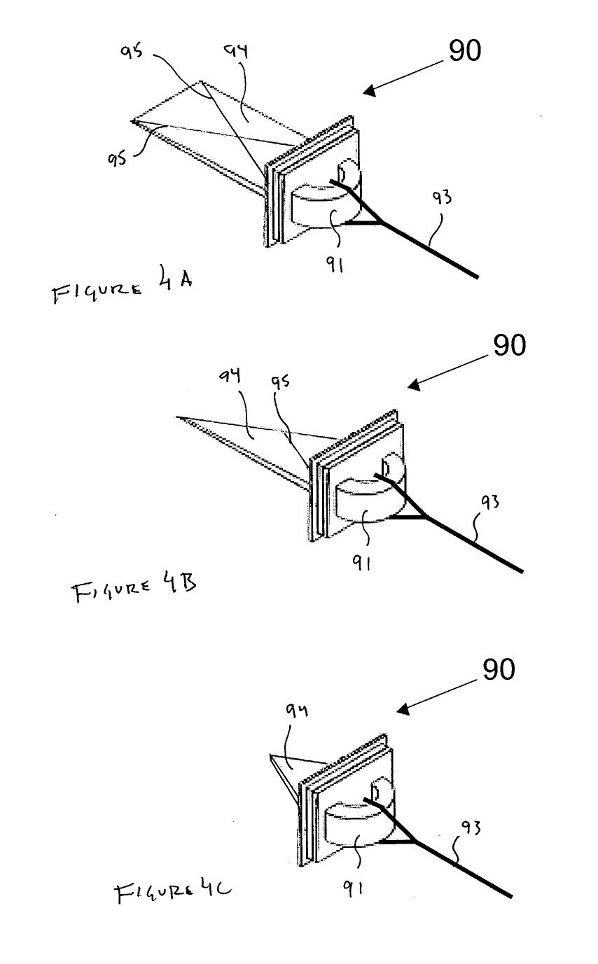

The variably-sensitive water resistant pull tab 90 is formed from high density, impact resistant plastic. The trip cord 93 is attached to a cord attachment point 91. A waterproof seal 92 is formed from a soft synthetic or natural rubber material and is attached to the pull tab 90 by a non-water soluble adhesive. The thin waterproof seal 92 aligns in such a way that the alignment folds 82 and 73 are completely sealed from the outside environment when the pull tab 90 is installed. When installed, a blade 94 of the pull tab is positioned between an upper leaf 74 of the dual spring switch 72 and the positive contact plate 81, insulating the one from the other. The variably-sensitive water resistant pull tab 90 has three sensitivity settings, as Illustrated in FIGS. 4A-4C. FIG. 4A illustrates the least sensitive setting. Increasing the sensitivity of the pull tab 90 is achieved by breaking off and discarding a single triangular piece of the blade 94 along a scored line 95, as shown in FIG. 4B. For even greater sensitivity, a second triangular piece can be broken off along a scored line 95, as illustrated in FIG. 4C. The variable sensitivity is achieved by reducing the surface area contacting both the positive contact plate 81 and the upper leaf 74 of the dual spring switch 72.

A water resistant audio siren 100 consists of a siren 101 coupled to a control circuit 104. The control circuit 104 is configured to supply an appropriate signal to cause the siren 101 to emit a high decibel sound, when a supply voltage is present across a positive and negative wires 108, 109. The control circuit 104 and siren 101 are constructed from materials chosen for maximum resistance to water and corrosion. The positive wire 108 is soldered or otherwise electrically connected to the positive power supply point 84, while the negative wire 109 is soldered or otherwise electrically connected to the negative contact plate 60 at the solder point 64.

According to the embodiment described, the negative power terminal 60, the positive power terminal 70, and the positive contact node 80 may each be manufactured from a single flat piece of material, cut and folded into the appropriate shape. This affords significant economy to the manufacture of the device. However, other embodiments of the invention include more complex configurations. For example, one of ordinary skill in the art can easily design a device configured to have the spotlights 120 and the siren 100 on separate circuits to allow selective activation. In another embodiment, the dual spring switch 72 is separated into two independent switches. In an additional embodiment, a different type of switch is employed. In one embodiment, only one switch and tripwire are incorporated into the device.

It will be recognized that there are many possible variations possible while remaining within the scope of the invention. For example, a microchip may be used to control the activation of the siren and lights. Such a chip would eliminate the need for discreet components of the control circuit. A microchip could also be employed to deactivate the spotlights or siren, in accordance with a pre-programmed time schedule, or in response to a photoelectric cell. In this way, the tripwire device could be configured to respond to intruders by sounding the siren during daylight hours and by illuminating the vicinity during nighttime hours. Additionally, infrared spotlights would be visible to observers using night vision aids, while an intruder might remain unaware of having triggered an alarm.

According to an embodiment of the invention, an infrared sensor is used to detect activation of the tripwire alarm.

Other embodiments of the invention include variations in size of the tripwire alarm device, alternative materials used to manufacture the device, etc. According to an embodiment of the invention, the siren is programmable to produce one of a variety of distinctive tone patterns, enabling an observer or sentry to differentiate between several devices deployed along a perimeter, thus providing information as to the location of an intrusion. In another embodiment, the tripwire alarm is configured to respond with a first tone pattern if a first one of the pull tabs is removed, and a second tone pattern if the second pull tab is removed.

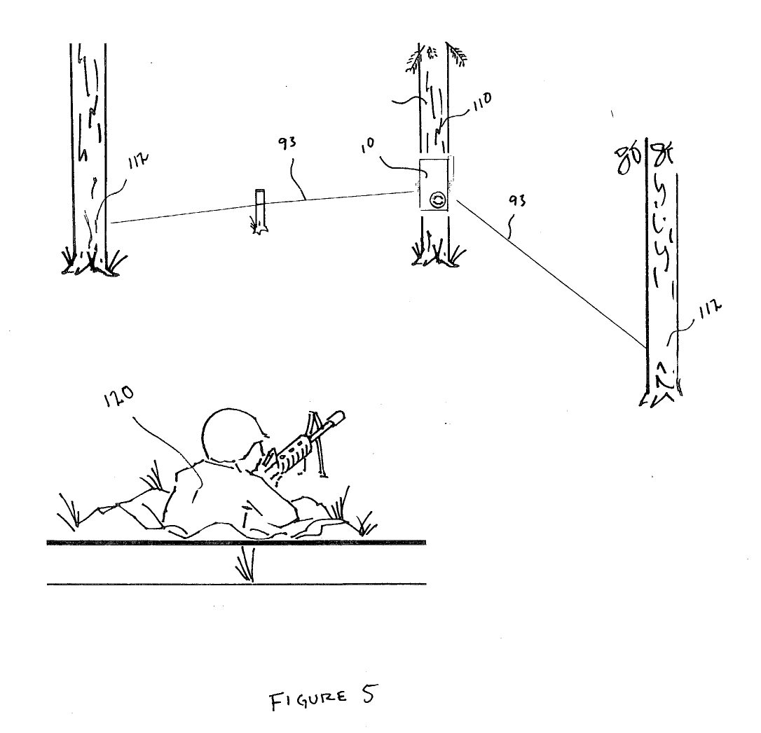

FIGS. 1 and 5 illustrate a typical installation of the tripwire alarm, according to an embodiment of the invention. The tripwire alarm 10 is attached to a tree 110, using a piece of wire 111. String or cord, fishing line, nails, and cable ties are some of the alternative means that may be employed to affix the tripwire alarm 10 in place. The tripwire alarm 10 may be attached to any suitable object or surface, such as a post, a stake driven into the ground for the purpose, or a section of a building. The tripwire alarm 10 may include a pressure sensitive adhesive strip on one side, for mounting the tripwire alarm 10 on a smooth surface. In such a case, the operator peels a protective cover from the strip to expose the adhesive and presses the tripwire alarm against a selected surface to affix the device thereto, with the exposed adhesive between the device and the surface.

The trip cords 93 are attached at one end to a respective one of the pull tabs 90, and at the other end to a convenient object, such as another tree, post, stake, etc. The trip cord 93 may be 50 meters or more in length, and may be placed 6-24 inches above the ground.

To install the tripwire alarm 10, an operator first ensures that the battery 40 is removed from the tripwire alarm to ensure the device does not activate during set up. While holding the waterproof housing 11 firmly against a tree 110 or other such object, the high strength chord or steel wire 111 is passed through one of the securing brackets 19, around the tree 110, then through the other securing bracket. Ends of the wire may then be tied together, or they may each be tied to one of the securing brackets 19.

With the battery 40 removed, the operator removes one of the two pull tabs 90. The trip cord 93 is then tied or otherwise attached to the pull tab 90 through the cord attachment point 91. The operator setting up the tripwire alarm 10 has-three sensitivity settings to choose from, as illustrated in FIGS. 4A-4C. The sensitivity setting is selected based upon the terrain, vegetation and possible avenues of approach, such at paths and roads. The operator breaks the blade 94 of the pull tab 90 as previously described in accordance with the desired sensitivity setting. The operator then slides the pull tab 90 into the pull tab notch 13, between the upper leaf 74 of the dual spring switch 72 and the positive contact plate 81 and continues to push until the waterproof seal 92 mates up with the side of the housing 11 to ensure the contact point is water resistant. The trip cord 93 is then extended to the side of the device along the desired perimeter from 5 to about 50 meters, and at a height of about 18 inches from the ground. The trip cord 93 is then firmly attached to the secondary attachment point 112 using sufficient tension to prevent the trip cord from significant sagging and to not pull the pull tab 90 from the pull tab notch 13. The second trip cord 93 is deployed in a direction roughly opposite that of the first trip cord 93, following the procedure previously described. The operator rechecks the pull tabs 90 to ensure that the seals 92 remain in contact with the housing.

The battery 40 is then inserted into the housing 11, ensuring that the positive and negative terminals 42, 41 are correctly aligned with the unidirectional terminal separator 54 to maintain correct polarity of the battery 40. The waterproof battery cover 30 is installed in such a way that the slots 32 engage the slips 23, 14 of the housing 11, pushing the positive and negative battery terminals 42, 41 against the positive and negative battery contact terminals 71 and 61.

According to one embodiment, the tripwire alarm is used in training exercises to train personnel in handling and placing the devices, and defending perimeters therewith. According to another embodiment, the tripwire alarm is used to train personnel in the avoidance or detection of such devices. In another application of the principles of the invention, the tripwire alarm is used in hazardous or combat situations to defend a perimeter.

Depending upon the application, the tripwire alarm may be emplaced in a variety of configurations. FIG. 5 illustrates a configuration in which the tripwire alarm 10 is affixed to a tree 110 and the trip cords 93 are stretched, parallel to the ground, to nearby trees 112. Such emplacements may be made with a plurality of tripwire alarms to completely cover a boundary or section. In such an application, for example, the secondary attachment point of a first tripwire alarm, to the left of the first alarm may also be used as the secondary attachment point of a second tripwire alarm, to the right of the second alarm. If each of the trip cords is extended about 50 meters from a tripwire alarm to the respective secondary attachment points, each alarm may be used to cover a perimeter section of 100 meters. Thus, a one kilometer section of perimeter would require only ten tripwire alarms. Additionally, for tactical reasons it may be desirable to use layers of defense, in which case additional tripwire alarms would be emplaced roughly parallel to each other.

In another application, the tripwire alarm may be used to train personnel in the detection of lethal tripwire devices. In such an application, the tripwire alarm is configured to mimic the behavior of such a lethal device. Accordingly, the trip cord 93 is extended from the housing only to the extent of the kill radius of a typical lethal device, and it is strategically placed, such as along a path or natural passage. It would not generally have a second trip cord deployed inasmuch as such devices usually employ only one tripwire.

In one application, it may be desirable for activation of the tripwire alarm to be undetected by an intruder, especially in nighttime conditions. In such a case, infrared spotlights may be used in the device, which are clearly visible to night vision equipped personnel but invisible to the naked eye. Additionally, the alarm might be configured to be activated indirectly. For example, the housing of the alarm might be attached to a tree at a higher level than previously described, while the trip cord is attached to a limb of the same or a neighboring tree, preferably above the head of an intruder, in such a way that movement of an individual past the limb will cause the alarm to be activated. In this way, the intruder will not notice the existence of the cord, and thus may remain unaware of the alarm. If the tripwire alarm is positioned within line of sight of a defensive position, an infrared sensor, similar to the type used to control home electronics, may be used to detect properly modulated infrared emissions from the alarm, even during daylight hours, permitting silent monitoring during daylight hours, as well. Other possible configurations will be evident to those skilled in the art.

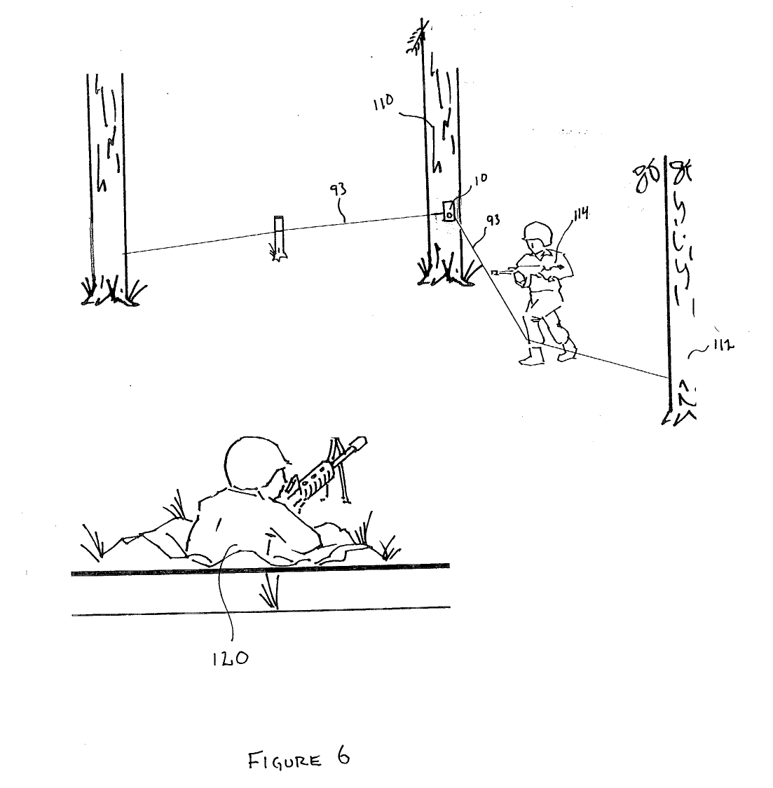

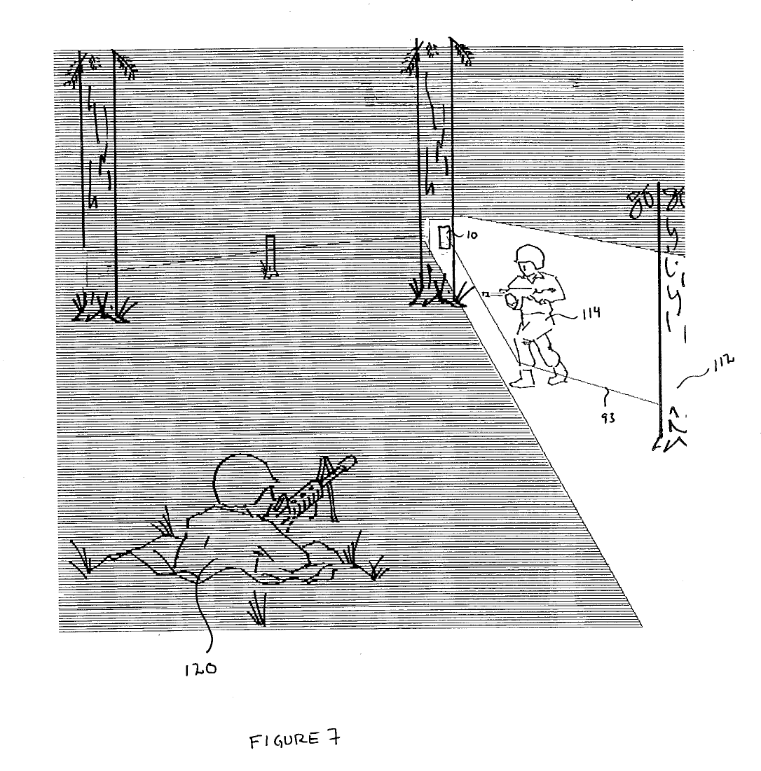

FIGS. 6 and 7 illustrate the tripwire alarm in use. The defensive position and sentry 120 is located about 50 to 300 meters from the tripwire device 10. The adversary 114 inadvertently pulls the flexible line 93. Due to the force exerted by the adversary 114, the pull tab 90 is removed from the pull tab notch 13. The upper leaf 74 of the dual spring switch 72 expands naturally and contacts the positive contact plate 81. This in turn provides power to the siren 100 and the pre-focused spot lights 120. In response to the siren 100, the sentry 113 is alerted to the adversary 114 and may take appropriate action.

FIG. 6 illustrates a daylight condition, while FIG. 7 shows the activation of the alarm during night or dark conditions. Under dark conditions, activation of the pre-focused spot light 120 illuminates the region around the alarm to permit visual acquisition of the target for identification. Alternatively, the alarm may incorporate infrared lights, which operate in the non-visible spectrum, which would allow the usage of night vision goggles for the sentry 113 to permit visual acquisition of the target for identification.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

From the foregoing it will be appreciated that, although specific embodiments of the invention have been described herein for purposes of illustration, various modifications may be made without deviating from the spirit and scope of the invention. Accordingly, the invention is not limited except as by the appended claims.

That which is claimed:

1. A tripwire warning device, comprising:
a housing;
a battery mounted within the housing;
an alarm mounted within the housing;
a first switch mounted to the housing and configured to prevent external elements, including moisture and dirt, from entering the housing, the first switch further configured to close a circuit between the alarm and the battery when activated, and further configured to be attached to a first trip cord, such that a selected tension on the first trip cord will activate the first switch.

2. The device of claim 1, further comprising a second switch mounted to the housing and configured to close a circuit between the alarm and the battery when activated, and configured to be attached to a second trip cord, such that a selected tension on the second trip cord will activate the second switch.

3. The device of claim 1, further comprising a first light mounted to the housing and configured to illuminate a region extending from a first side of the housing when activated, and further including circuitry configured to activate the first light with the activation of the first switch.

4. The device of claim 3 wherein the circuitry includes a photoelectric cell, and wherein the circuitry is configured to disable the light while illumination of an area surrounding the housing exceeds a selected level.

5. The device of claim 3 wherein the light is configured to produce light in a spectrum that is not visible to human eyes.

6. The device of claim 3, further comprising a second light mounted to the housing and configured to illuminate a region extending from a second side of the housing when activated, and wherein the circuitry is further configured to activate the second light with the activation of the first switch.

7. The device of claim 1 wherein the alarm includes circuitry configured to selectively disable the alarm.

8. The device of claim 7 wherein the alarm circuitry includes a photoelectric cell, and wherein the circuitry is configured to disable the alarm while a level of illumination immediately around the housing does not exceed a selected level.

9. The device of claim 1 wherein the housing includes a battery cover configured to prevent external elements, including moisture and dirt, from entering the housing, the battery cover further configured to enclose a compartment into which the battery is mounted.

10. The device of claim 9, wherein the battery compartment is configured to accommodate the battery according to a selected polarity, such that the battery cannot be fully mounted therein with a reversed polarity.

11. The device of claim 1, further comprising alarm circuitry that incorporates a microchip configured to condition a signal for the alarm.

12. The device of claim 1 wherein the alarm produces an audible signal when activated.

13. The device of claim 1 wherein the selected tension required to activate the switch is adjustable.

14. The device of claim 1 wherein the first switch comprises:
a conductive spring biased against a conductive plate;
an insulative blade having a connection point for connection of the first trip cord, the blade interposed between the spring and the plate such that the selected tension on the first trip cord is sufficient to pull the blade from between the spring and plate and enable the spring to contact the plate and complete a circuit.

15. The device of claim 14 wherein the blade includes scored marks thereon to facilitate breaking parts of the blade to reduce the selected tension.

16. A method, comprising:
positioning a battery-powered tripwire alarm device in a first position on a perimeter of a military defensive position, the device configured to be activated by a selected tension on a first trip cord attached to the device; and
extending the first trip cord between the alarm device and a second position on the perimeter; and
monitoring the device from behind the perimeter.

17. The method of claim 16, further comprising sounding an audible alarm when the device is activated.

18. The method of claim 16, further comprising illuminating a region adjacent to the device when the device is activated.

19. The method of claim 17 wherein the illumination is in a spectrum not visible to unaided human eyes.

20. The method of claim 15 wherein the device is further configured be activated by a selected tension on a second trip cord attached to the device, and wherein the method further comprises extending the second trip cord between the alarm device and a third position on the perimeter.

21. The method of claim 15, further comprising:
positioning an additional battery powered tripwire alarm device in a fourth position on the perimeter of a military defensive position, the additional device configured to be activated by a selected tension on a third trip cord attached to the device; and
extending the first trip cord between the additional alarm device and a fifth position on the perimeter.

22. A method of instruction, comprising:
engaging, as part of a first group of participants, in non-lethal, mock combat against a second group of participants;
establishing a defensive perimeter between the first group and the second group; and
directing a member of the first group to position a battery powered tripwire alarm device in a first position on the defensive perimeter, the device configured to be activated by a selected tension on a first trip cord attached to the device, and to position the first trip cord between the alarm device and a second position on the perimeter.

23. The method of claim 21, further comprising evaluating a level of skill of the member of the first group based upon a response of the tripwire device to movement of members of the second group past the device.

24. The method of claim 21 wherein the directing step includes encouraging the member of the first group to be creative in positioning and concealing the battery powered tripwire device.

25. The method of claim 21, further comprising querying, following an end of the mock combat, a member of the second group regarding the effectiveness of the placement of the device and methods employed by the second group to avoid the tripwire device.

26. A method of instruction, comprising:
engaging, as part of a first group of participants, in non-lethal, mock combat against a second group of participants;
establishing a defensive perimeter between the first group and the second group; and
directing a member of the first group to position a battery powered tripwire alarm device in a first position on the defensive perimeter, the device configured to be activated by removal of a pull tab in response to a selected tension on a first trip cord attached to the pull tab, and to position the first trip cord between the alarm device and a second position on the perimeter.
